(19) United States
(12) Patent Application Publication
(10) Pub. No.: US 2006/0265335 A1
(43) Pub. Date: Nov. 23, 2006

(54) System and method for issuing prepaid debit card at point of sale

(76) Inventors: Peter Hogan, O'Fallon, MO (US); Alan Roman, Wildwood, MO (US); Miladys Felix, Norwalk, CT (US)

Correspondence Address: BAKER & BOTTS, 30 ROCKEFELLER PLAZA, 44TH FLOOR, NEW YORK, NY, 10112, US

(21) Appl. No.: 11/389,799

(22) Filed: Mar. 27, 2006

Related U.S. Application Data
(60) Provisional application No. 60/666,283, filed on Mar. 29, 2005.

(51) Int. Cl. G06Q 99/00

(52) U.S. Cl. 705/65

(57) ABSTRACT

A system and method for direct loading of prepaid debit cards at point of sales (POS) devices via an Internet channel is provided. A centralized on demand model is provided so that any merchant operating a POS device can issue a prepaid debit card to a customer.

### CROSS-REFERENCE TO RELATED APPLICATIONS

This application claims the benefit of U.S. provisional patent application No. 60/666,283 filed on Mar. 29, 2005, which application is hereby incorporated by reference herein in its entirety.

### FIELD OF THE INVENTION

The present invention relates to systems and methods for conducting payment transactions in e-commerce. More particularly, the invention relates to systems and methods for conducting payment card transactions at point of sale devices via an Internet connection.

### BACKGROUND OF THE INVENTION

A debit card is an ISO 7810 card which physically resembles a credit card, and, like a credit card, is used as an alternative to cash when making purchases. However, when purchases are made with a debit card, the funds are withdrawn directly from the purchaser's bank account. A debit card is also similar to a stored-value card in that it represents a finite amount of money owed by the card issuer to the holder; the two card types differ, however, in that stored-value cards are generally anonymous, while debit cards are generally associated with an individual's bank account. Debit cards usually offer some protection against loss, theft, or unauthorized use, while stored-value cards usually do not. The terms debit card and store-value card are used interchangeably herein if appropriate in the context.

Smart card technology is becoming commonplace in our culture and daily lives. A smart card is a card that is embedded with either a microprocessor and a memory chip or only a memory chip with non-programmable logic. The microprocessor card can add, delete, and otherwise manipulate information on the card, while a memory-chip card (for example, pre-paid phone cards) can only undertake a pre-defined operation. Smart cards, unlike magnetic stripe cards, can carry all necessary functions and information on the card. Therefore, they do not require access to remote databases at the time of the transaction. Debit cards may be based on smart card technology or on earlier magnetic stripe card technology.

Consideration is being given to improving payment card systems and transaction methods. In particular, attention is directed to loading or updating values in prepaid debit cards that are in use in the field, or, alternatively, to issuing new prepaid debit cards in the field.

### SUMMARY OF THE INVENTION

The present invention provides systems and methods for prepaid debit card loading functions at point of sale (POS) devices via an Internet channel. A centralized on-demand model is provided so that any merchant operating a POS device can issue a prepaid debit card.

The loading functions provided at the POS device are understood to include all common debit card processing functions, including, but not limited to, new account setup, activation, reloading, and account closing of the prepaid debit cards.

The inventive systems and methods are designed to beneficially exploit Internet connections or other electronic communication between a plurality of merchants operating POS devices and a payment card issuer network. A centralized on-demand model is provided so that any merchant operating a POS device can issue a prepaid debit card. The merchant may operate the POS device in a merchant network having a merchant-specific or -proprietary protocol. Requests or demands for prepaid debit card processing functionality generated by the merchant (e.g., at the POS device) are encrypted and transmitted securely over the Internet, for example, under an HTTPS protocol. The payment card issuer network converts the request or demand received over the Internet into payment card industry standard format (e.g., ISO 8583) for processing and record keeping. Conversely, responses to the request or demand are generated by the payment card issuer network in the payment card industry standard format. These responses are transmitted to the merchant network over the Internet under the HTTPS protocol or any other secure protocol. The merchant network translates the responses received under the HTTPS protocol to the local merchant-specific or -proprietary protocol for action at the originating the POS device.

Further features of the invention, its nature, and various advantages will be more apparent from the accompanying drawings and the following detailed description.

### BRIEF DESCRIPTION OF THE DRAWINGS

FIG. 1 is a block diagram illustrating a system configured for conducting a debit card transaction in accordance with the principles of the present invention.

FIG. 2 is a flow diagram illustrating exemplary steps in a process for authorizing prepaid debit cards in accordance with the principles of the present invention.

### DESCRIPTION OF THE INVENTION

Systems and methods are provided for direct loading of prepaid debit cards at point of sale (POS) devices via an Internet channel. A centralized on-demand model is provided so that any merchant operating a POS device can issue a prepaid debit card to a customer.

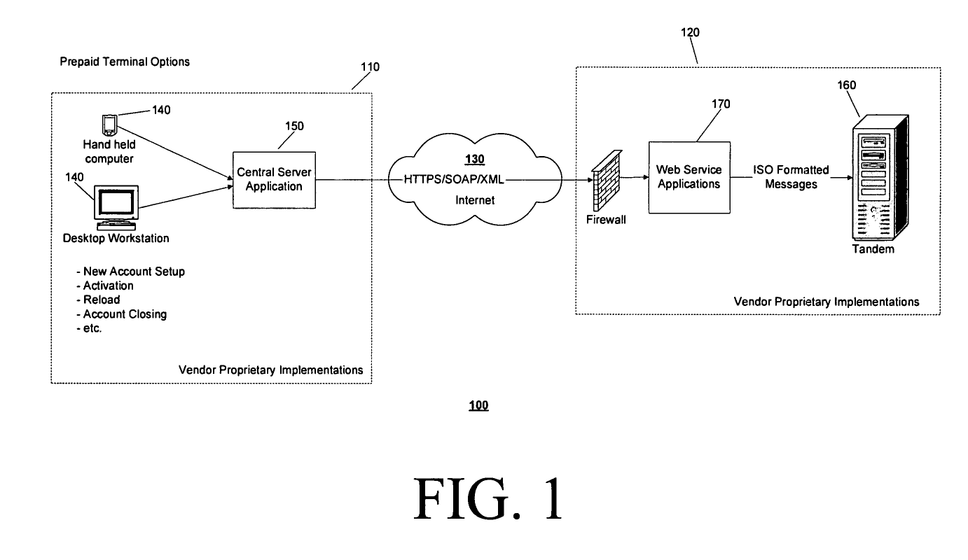

FIG. 1 shows an exemplary system 100, which is configured for direct loading of prepaid debit cards by POS devices. System 100 may be operated by merchants in conjunction with a payment card provider (e.g., MasterCard). System 100 is provided with a centralized on-demand model.

System 100 includes a merchant network 110, which can communicate securely with the payment card provider's network 120 via an electronic communications link (e.g., Internet 130). The merchant's network 110 may include one or more POS devices 140, which are suitably configured to communicate with a central server 150. The configuration of merchant network 110 may be proprietary to a specific merchant. Similarly, the particular applications run on merchant network 110 may be proprietary to the specific merchant.

In operation, POS 140 may be used to generate debit card authorization requests and processing. POS 140 may include suitable hardware, software, and user interfaces to communicate relevant information related to a desired transaction for processing by central server 150. The relevant information that may be communicated to central server 150 may, for example, include initial account setup information, an activation request, a debit card load request, and an account close request. Such information may be communicated in a proprietary POS protocol.

Central server 150 (or an other suitable server) in merchant network 110 may receive information or requests communicated by POS devices 140 in the proprietary protocol, and translate that information or requests for subsequent transmission over communications link 130 to the payment card provider. Central server 150 may, for example, translate the information or request into a Simple Object Access Protocol (SOAP/XML) request. The SOAP/XML request may be received by the payment card provider's network 120 via HTTPS.

Payment card provider network 120 may include a suitable web service application or server 170 and a processing server (e.g., tandem server 160). These applications and servers are configured to receive and further process the HTTPS requests. For example, web service application 170 may be configured to translate the HTTPS requests and information into an ISO data format. This data is then processed (e.g., by tandem server 160) so that a prepaid record system can be updated (e.g., indicating an upload of a debit card). Network 120 may be configured to send a responsive acknowledgement or error message as appropriate to POS device 140 to confirm the transaction.

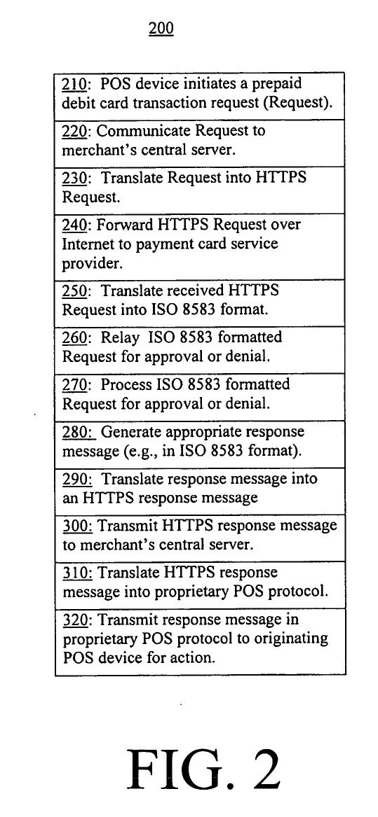

FIG. 2 shows an exemplary debit card authorization or generation process 200, which may be implemented over system 100. In process 200, first, at step 210, a prepaid debit request is initiated from a POS device, which may, for example, be located at a checkout counter on the floor in a merchant's retail store (e.g., FIG. 1 POS Device 140). The request may include suitable prepaid debit account or transaction information.

Next, at step 220, the POS device communicates this request to a POS central server (e.g., FIG. 1 server 150), which may be supported or maintained by the merchant at a central location or office. The communication may be securely transmitted over a POS network protocol to the POS central server. The POS network protocol may be specific and/or proprietary to the merchant. At step 230, the POS central server translates this request into an HTTPS request. At step 240, the HTTPS request is forwarded to a third party (e.g., a card provider such as MasterCard) over the Internet. The HTTPS request may be received and processed at the card provider's Prepaid Debit POS application server (e.g., FIG. 1 application server 170). Conventional electronic security procedures (e.g., digital certificates and encryption) may be employed to mutually authenticate the POS central server and the Prepaid Debit POS application server and to secure communications between the two servers.

At step 250 of the process, the card provider's Prepaid Debit POS application server translates the received HTTPS request into a standard format (e.g., ISO 8583 format). At step 260, the Prepaid Debit POS application server relays the formatted request to a Prepaid Debit Tandem server (e.g., FIG. 1 application server 160).

At step 270, the ISO 8583 formatted request is processed by the Tandem server as a result of which the request may be approved or denied. At step 280, the Tandem server generates an appropriate response message in ISO format. At steps 290-310, this response message is successively translated into HTTPS by the application server and transmitted to the merchant's central server for further translation and transmission to the originating POS device. The originating POS device, which receives the approval or denial message in the merchant's proprietary POS protocol, may then act on the received response to its request, at step 320.

At each step of translation or transmission, suitable error messages may be generated and added to the messages or requests forwarded to an upstream server, as may be appropriate or necessary in case of malfunctions or errors.

It will be understood that the foregoing is only illustrative of the principles of the invention, and that various modifications can be made by those skilled in the art without departing from the scope and spirit of the invention.

1. A method for loading prepaid debit cards at a point of sale device (POS) operated by a merchant, the method comprising:
originating a prepaid debit card transaction request at the POS device;
translating the request into an encrypted request;
forwarding the encrypted request over the Internet to a payment card service provider;
translating the encrypted request received by the payment card service provider into an industry standard formatted request;
processing the industry standard formatted request;
transmitting a result of the processing in a response message to originating POS device for action.

2. The method of claim 1, wherein originating a prepaid debit card transaction request at the POS device further comprises transmitting the prepaid debit card transaction request to a central server operated by the merchant.

3. The method of claim 1, wherein originating a prepaid debit card transaction request at the POS device comprises originating the prepaid debit card request in a POS protocol that is proprietary to the merchant.

4. The method of claim 1, wherein translating the request into an encrypted request comprises translating the request into an HTTPS request.

5. The method of claim 1, wherein translating the encrypted request received by the payment card service provider into an industry standard formatted request comprises translating the encrypted request into an ISO 8583 formatted request.

6. The method of claim 1, wherein processing the industry standard formatted request leads to a result indicating approval or denial of the request.

7. The method of claim 6, wherein transmitting the result of the processing in a response message to the originating POS device comprises generating a response message in industry standard format.

8. The method of claim 4, wherein transmitting the result of the processing in a response message to the originating POS device comprises generating a response message in an ISO 8583 standard format.

9. The method of claim 8, further comprising translating the response message in an ISO 8583 standard format into an encrypted format for transmission over the Internet.

10. The method of claim 9, wherein the encrypted format is HTTPS.

11. The method of claim 1, wherein transmitting a result of the processing in a response message to the originating POS device for action comprises transmitting the result to the originating POS device via a server operated by the merchant.

12. The method of claim 11, wherein transmitting the result to the originating POS device via a server operated by the merchant comprises transmitting the result in a merchant-proprietary POS protocol.

13. A system for loading prepaid debit cards at a point of sale device (POS) operated by a merchant, the system comprising:
a merchant network comprising a server in communication with the POS device, wherein the merchant server and the POS device operate under a merchant-specific POS protocol;
a payment card provider's network which is linked to the merchant network over the Internet,
wherein the merchant network comprises an application for encrypting a prepaid debit card transaction request generated at the POS device, and transmitting such prepaid debit card transaction request under a secure protocol over the Internet to the payment card provider's network, and wherein the payment card provider's network comprises a web service application for converting the prepaid debit card transaction request received over the Internet into an industry standard formatted request for further processing.

14. The system of claim 13, wherein the merchant network comprises an application for encrypting a prepaid debit card transaction request generated at the POS device, and transmitting such prepaid debit card transaction request under an HTTPS protocol over the Internet to the payment card provider's network.

15. The system of claim 13, wherein the payment card provider's network comprises a web service application for converting the prepaid debit card transaction request received over the Internet into an ISO 8583 formatted request for further processing.

16. The system of claim 13, which is further configured so that a response to the prepaid debit card transaction request generated at the POS device is generated by the payment card provider's network in ISO 8583 format and translated into HTTPS protocol for transmission over the Internet to the merchant network.

17. The system of claim 13, which is further configured so that a response to the prepaid debit card transaction request generated at the POS device received over the Internet under an HTTPS protocol is translated by the merchant network to a response under merchant-specific POS protocol for action by the POS device.
